(19) United States
(12) Patent Application Publication
(10) Pub. No.: US 2016/0203539 A1
(43) Pub. Date: Jul. 14, 2016

(54) User Defined Categorization of Marketplace Listings

(71) Applicant: Hieu Trung Tran, San Jose, CA (US)

(72) Inventor: Hieu Trung Tran, San Jose, CA (US)

(21) Appl. No.: 14/287,013

(22) Filed: May 24, 2014

Related U.S. Application Data
(60) Provisional application No. 61/827,014, filed on May 24, 2013.

(51) Int. Cl. G06Q 30/06

(52) U.S. Cl. CPC G06Q 30/0625; G06Q 30/0641

(57) ABSTRACT

A system and methods of categorizing online marketplace items, implemented by having marketplace participants submit their definitions of one or more non existing item categories and associated attributes whereas contributing participants of similar items vote for the best submission(s) to anoint those submissions with the highest votes for adoption by the marketplace.

### BACKGROUND OF THE INVENTION

1. Field of the Invention

The present invention relates generally to the organization of offered items by online marketplaces, and more specifically to the enablement of items organization driven by participants through peer selection processes.

2. Description of the Related Art

Plurality of online marketplace exists. Ebay and Amazon are online consumer-to-consumer and business-to-consumer marketplace services offering a wide range of products. NYSE and NASDAQ are online and offline brokering services for stocks and commodities. Operators of these services define the categorization of marketplace items and their attributes. Exemplary categorization of items on marketplaces such as Ebay and Amazon comprising of electronics, audio video, computers, mobile phones, tablets, and others. Correspondingly, exemplary attributes of said categorization comprising of size, capacity, speed, color, and others. Similarly, exemplary categorization of items on exchanges such as NYSE and NASDAQ comprises of stocks, bonds, agricultural, live stock, energy, precious metals, and others. Attributes of said categorization comprise of price, strike date, volume, weight, and others.

Operators of aforementioned services must define the categorization and attribute(s) of the items prior to their listings. In this manner, significant resources and time would be required to expand coverage of their marketplaces. Furthermore, the services also lack the ability to list items that do not fit into existing categories without having the service operators add the definition of new categories to their marketplace, often with significant wait time. Exemplary items that may not be effectively categorized and listed by services like Ebay and Amazon are local items with expiration date such as tickets for local shows and sporting events, professional services, home repair services, restaurant time-limited discounts and promotions, and similar. Likewise, NYSE, NASDAQ, and other financial exchanges may not be able to effectively categorize and list exotic derivatives comprising exotic options, interest rate derivatives, weather derivatives and others due to their various attributes customized for different clients and markets.

### SUMMARY OF THE INVENTION

Traditional marketplaces are online or offline repositories of (“listings”) representing items offered. A listing typically comprises of aggregations of data, content, or descriptive information associated with, but not limited to merchandises, services, goods, products, persons, organizations, or similar items. Marketplace websites and information systems organize listings by related groups or (“categories”), exemplified by electronics, automotive as in consumer marketplace, or energy, metals, or agriculture as in exchanges. Categorization of listings in hierarchically order facilitates search and perusal by buyers and sellers (“participants”). A category has characteristics (or “attributes”) that are specific and relevant to the listings under that category. In the exemplary automotive category, listing attributes comprise of make, model, year, mileage, and color of vehicle.

The present invention is a users-driven system for categorizing marketplace items. Participants of such marketplaces search and peruse listings for items of interest. Not having found the category for the searched item, said participants are given the option to create a new category and associated attribute to represent that item, and submit said categorization to the marketplace. In the event that a multitude of submissions exists for the same category, submitters are asked to vote for the most relevant submission. The submission with the highest total relevancy vote(s) is adopted and deployed in the marketplace.

### BRIEF DESCRIPTION OF THE DRAWINGS

For a more complete understanding of the present invention, reference is made to the following Detailed Description taken in conjunction with the following accompanying drawings in which:

FIG. 1 is a flow chart diagram of an exemplary usage scenario of a participant creating and submitting a new category for items;

FIG. 2 is a flow chart diagram of an exemplary usage scenario of a participant using the Category Creator or to create and submit new category, or view the results of previously submitted categories;

### DETAILED DESCRIPTION OF THE INVENTION

Marketplace consists of online and offline repositories of listings that enable participants to search, peruse, and view details of offered items. Marketplace listings representing merchandises, services, goods, products, persons, organizations, or similar comprise of multimedia data (photos, audios and videos) and text describing details of the represented item to prospective buyers. Marketplace websites and information systems organize listings by related groups or (“categories”), exemplified by electronics, automotive, energy, metals, or agriculture. The criteria for organizing listings vary and can comprise of forms and functions of offered items, their geographic locations, prices, quantities, and other relevant factors. Categorization of listings in hierarchically order facilitates convenient search and perusal by marketplace participants. Listing attributes are specific and relevant to the items represented by the listing. Listings qualified by a higher number of attributes are generally more relevant to search and perusal results. In the exemplary automotive listing, attributes may comprise of color, make, model, year, mileage, and condition.

The present invention is a participant-driven system for categorizing marketplace items. In this fashion, the invention can be utilized to implement a marketplace with high degree of dynamism and diversity at relatively lower maintenance and development costs to the operator. In said marketplace, buyers and sellers search and peruse listings for items of interest (“searches”) using either apps on their mobile devices or browsers on personal computers (“marketplace user interface”). In the event that such searches do not produce satisfactory results due to the reasons comprising of the items not belonging to a classified category, the marketplace user interface offers participants the option to create a new category and attribute(s) used to classify said items. The marketplace user interface for creating and managing category (“Category Creator”) enables the participant to specify a plurality of aspects associated with the categorization of an item comprising name and description, and one or more attributes. Participants can create and submit one or more categories to the marketplace. In the event that a multitude of submissions exists for the same category (for example, “electronics”), or group of similar categories (for example, “toys”, “toys for kids”, and “egos”), participants can use the Category Creator to view submissions from other participants, and rate them based on relevancy. Finally, the marketplace notifies participants through the Category Creator or other means of electronic communication such as email, and text message of the results of their submissions, and those categories with the highest number of votes selected for deployment. Participants at this point have the option of offering items for sale or search for items to purchase under the new category.

### DESCRIPTION OF THE PREFERRED EMBODIMENTS

Preferred embodiments of the present invention will now be described with continued reference to the drawings.

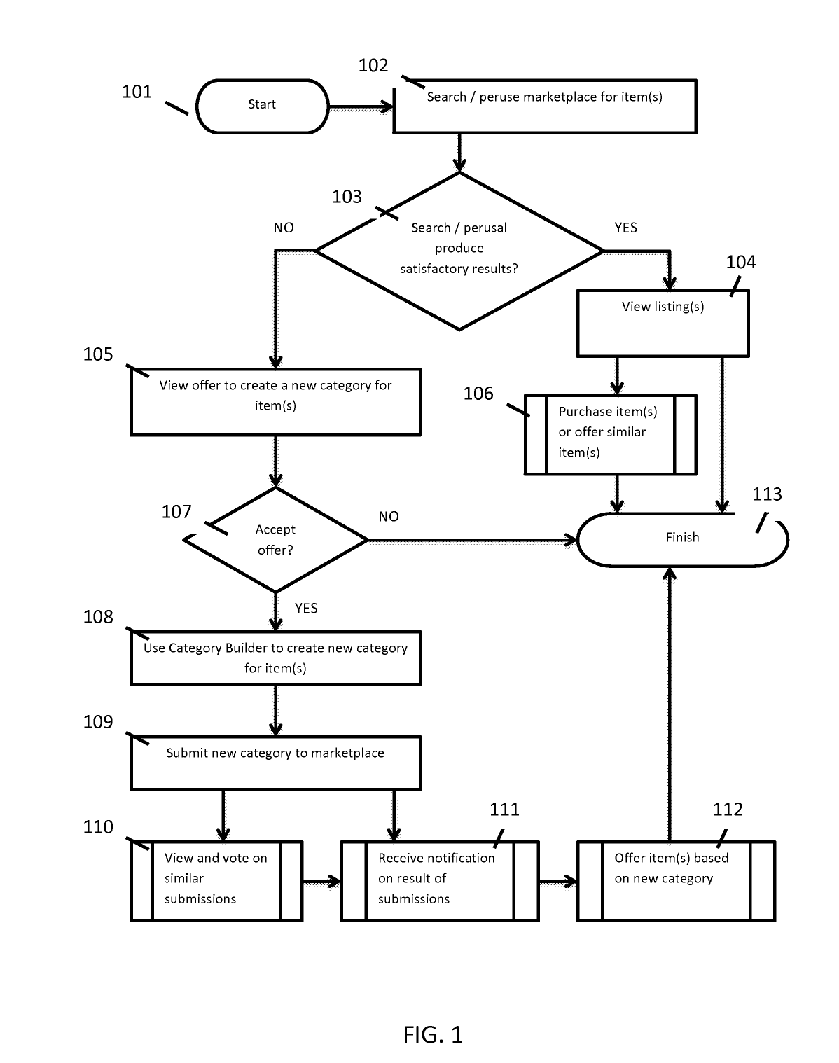

A flow chart diagram of an exemplary usage scenario of a participant creating and submitting a new category for items is shown in FIG. 1. Participant searches or peruses the marketplace for specific item(s) (102). Pending successful outcome (103), the participant views the listing from the generated searches or perusal results (104), and either purchases the item(s), offers similar ones for sale (106), or finish (113). If a category for the item(s) does not exist, the marketplace user interface offers the participant the option of creating one (105). In choosing to do so, the participant uses the Category Builder to create a new category for item(s) (108), and submit it to the marketplace (109). Optionally, the participant can view and vote on similar submissions by others (110), or receive notification from the marketplace regarding the outcome of own submission (111). The participant can choose to list the item under the newly created category (112), and finish (113).

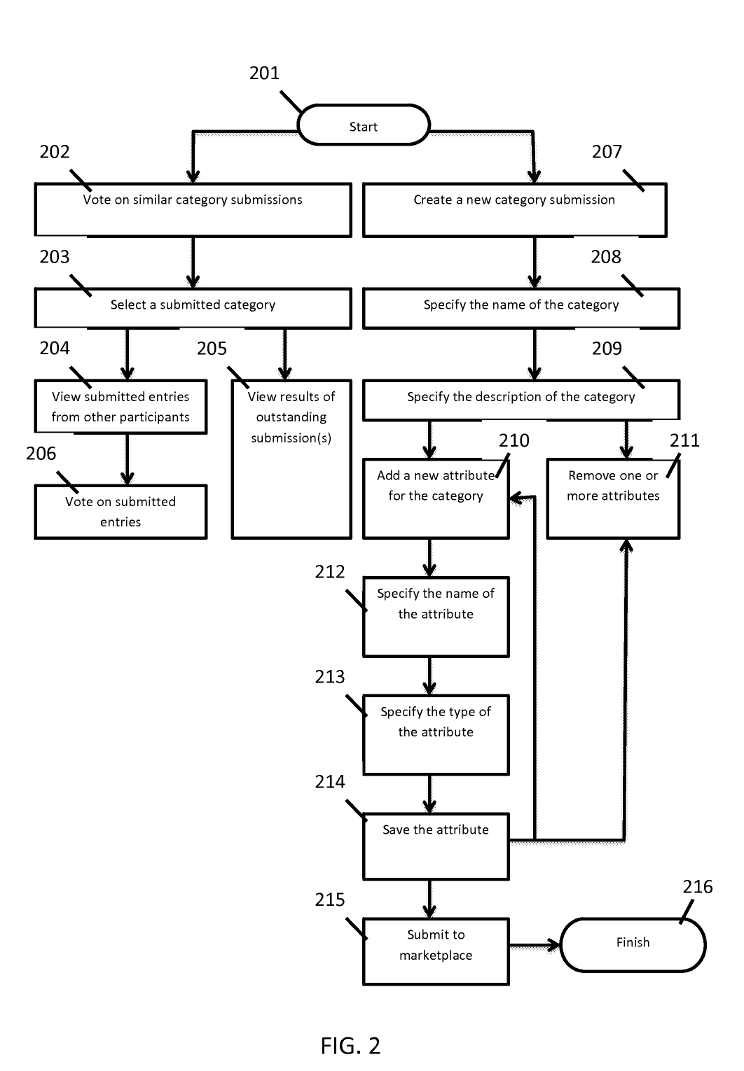

A flow chart diagram of an exemplary usage scenario of a correspondent using the Category Creator to create one or more categories (207) or vote on submitted categories (202) in accordance with the present invention is referred to in FIG. 2. To create a new category, the correspondent specifies the name of the category (208), and description of the category (209). A new attribute is added to the category (210), along with its name (211) and type (212). The type of the attribute comprises of check boxes, radio buttons, text fields, and others. Once added, the correspondent can save the attribute, add other attributes, or submit the category to the marketplace (215). Alternatively, participant can also remove one or more previously added fields from the category prior to submitting (211).

What is claimed is:

1. A system of marketplace with a plurality of mobile devices or computers operated by market participants and participating in commerce, comprising:
1. A program executing on a mobile device, personal computer, or cloud-based services accessed via a web browser, wherein said program or service provides search and perusal services for listings of marketplace items;
2. A program executing on a mobile device, personal computer, or cloud-based services accessed via web browser, wherein said program enables creating and submitting category to the marketplace, rating similar submissions by others, and receiving notification of outcome from own submission (“Category Creator”);

2. A system of marketplace of claim 1 wherein the newly created category comprising:
1. A short name;
2. A description of the category;
3. One of more attributes;

3. A system of marketplace of claim 2 wherein the attribute comprising:
1. A descriptive label;
2. A type;

4. A system of marketplace of claim 3 wherein the type of attribute comprising:
1. Check box;
2. Radio button;
3. Text field;

5. A system of marketplace of claim 1 wherein the rating of similar submissions comprising:
1. A number, count, or quantifiable measure commensurate the perceived relevancy;

6. A system of marketplace of claim 1 wherein the rating of similar submissions comprises of:
1. Individual attribute(s);
2. Overall category submission;

7. A method of extending listing coverage for a marketplace utilizing a plurality of mobile devices and personal computers, comprising of steps by market participants:
1. Searching or perusing of item(s);
2. Accepting offer by marketplace to create new category for item(s) in the event that such category does not exist;

3. Utilizing the Category Creator to define one or more new categories;

4. Uploading new categories to the marketplace;

5. Rating similar category submissions by other market participants;

6. Viewing the outcome of own submission;

7. Utilizing the new category to list item(s);

8. A method of extending listing coverage of claim 7 wherein the definition of new category further comprising the steps of:
1. Specifying a short name;
2. Specifying a description of the category;
3. Adding one of more attributes;

9. A method of extending listing coverage of claim 8 wherein the addition of attributes further comprising the steps of:
1. Specifying a descriptive label;
2. Specifying a type;

10. A method of extending listing coverage of claim 9 wherein the specification of an attribute type comprise the steps of:
1. Selecting from check box, radio button, or text field;

11. A method of extending listing coverage of claim 7 wherein the rating of similar category submissions by other market participants comprise the steps of:
1. Assigning a number, count, or quantifiable measure commensurate the perceived relevancy;

12. A method of extending listing coverage of claim 7 wherein the rating of similar category submissions by other market participants comprise the steps of:
1. Rating of individual attributes;
2. Rating of the overall submission;
